(19) United States
(12) Patent Application Publication
(10) Pub. No.: US 2008/0218292 A1
(43) Pub. Date: Sep. 11, 2008

(54) Low voltage data transmitting circuit and associated methods

(76) Inventors: Dong-Uk Park, Yongin-si (KR); Jin-Ho Seo, Seoul (KR); Jae-Jin Park, Seongnam-si (KR)

Correspondence Address: LEE & MORSE, P.C., 3141 FAIRVIEW PARK DRIVE, SUITE 500, FALLS CHURCH, VA, 22042, US

(21) Appl. No.: 12/073,313

(22) Filed: Mar. 4, 2008

(30) Foreign Application Priority Data
Mar. 8, 2007 (KR) 2007-0022716
Nov. 13, 2007 (KR) 2007-0115186

(51) Int. Cl. H01P 5/12

(52) U.S. Cl. 333/103

(57) ABSTRACT

A low voltage data transmitting circuit (LVDTC) may be connected to a first transmission line that transmits a first voltage signal to a receiver and a second transmission line that transmits a second voltage signal to the receiver. The LVDTC includes a first resistor coupled to the first transmission line, a second resistor coupled to the second transmission line, and a control unit coupled to the first transmission line and the second transmission line, the control unit being configured to control voltage levels of the first and second voltage signals such that the voltage levels of the first and second voltage signals are higher than a ground voltage level of the receiver, wherein the first and second voltage signals may constitute a differential pair.

### BACKGROUND OF THE INVENTION

1. Field of the Invention

Embodiments relate to a data transmitting circuit and associated methods. More particularly, embodiments relate to a low voltage data transmitting circuit and associated methods.

2. Description of the Related Art

With the explosive growth and usage of the Internet, an amount of data being transmitted in every communication field is increasing. Also, data streams for digital video, HDTV and color graphics require higher bandwidths.

Transmission systems for large amounts of data require new interfacing schemes for high speed data transmission such as a low voltage differential signaling (LVDS) scheme, a reduced swing differential signaling (RSDS) scheme, and a scalable low voltage signaling (SLVS) scheme. These interfacing schemes have characteristics such as a fast bit rate, lower power consumption, and better robustness to noise.

However, in the SLVS scheme, a transmitter and a receiver may have different power supply voltages. Thus, a ground voltage level of the receiver may be different from a ground voltage level of the transmitter. As a result, there may be a voltage difference between a common mode voltage of the transmitter and a common mode voltage of the receiver. Thus, the receiver may misinterpret a transmitted signal from the transmitter as a result of the voltage difference, and an interface error may occur. In addition, when a signal level of the transmitter is not recognized by the receiver, the receiver may not operate at a desired speed, or may not operate at all. Additionally, in the SLVS scheme, a short-circuit current may occur and influence output waveforms during a switching operation.

### SUMMARY OF THE INVENTION

Embodiments of the invention are therefore directed to substantially obviate one or more problems due to limitations and disadvantages of the related art.

It is therefore a separate feature of an embodiment of the invention to provide a low voltage data transmitting circuit (LVDTC) that may operate stably even when a ground voltage level of a transmitter and a ground voltage level of a receiver are different from each other.

It is therefore a separate feature of an embodiment of the invention to provide a low voltage data transmitting system (LVDTS) that may operate stably even when a ground voltage level of a transmitter and a ground voltage level of a receiver are different from each other.

It is therefore a separate feature of an embodiment of the invention to provide a method of low voltage data transmitting (LVDT) that may operate stably even when a ground voltage level of a transmitter and a ground voltage level of a receiver are different from each other.

It is therefore a separate feature of an embodiment of the invention to provide an LVDTC capable of reducing a short-circuit current.

It is therefore a separate feature of an embodiment of the invention to provide an LVDTC capable of reducing a chip-size and providing matched impedance.

It is therefore a separate feature of an embodiment of the invention to provide an LVDTC, an LVDTS and/or a method of LVDT that may transmit signals stably when a transmitter and a receiver have different ground levels.

It is therefore a separate feature of an embodiment of the invention to provide an LVDTC that provides a stable output waveform by reducing short-circuit current that occurs during a switching operation.

It is therefore a separate feature of an embodiment of the invention to provide an LVDTC that reduces a circuit size and provides a desired termination resistance.

At least one of the above and other features and advantages of the invention may be realized by providing a low voltage data transmitting circuit (LVDTC) adapted to be connected to a first transmission line that transmits a first voltage signal to a receiver and a second transmission line that transmits a second voltage signal to the receiver, the LVDTC including a first resistor coupled to the first transmission line, a second resistor coupled to the second transmission line, and a control unit coupled to the first transmission line and the second transmission line, the control unit being configured to control voltage levels of the first and second voltage signals such that the voltage levels of the first and second voltage signals are higher than a ground voltage level of the receiver, wherein the first and second voltage signals constitute a differential pair.

The control unit may include a reference voltage generator configured to generate a reference voltage for the first and second voltage signals, a first voltage regulator configured to receive the reference voltage, configured to provide a first output signal having a first voltage level according to the ground level of the receiver, and configured to control the voltage level of the first voltage signal, and a second voltage regulator configured to receive the reference voltage, configured to provide a second output signal having a second voltage level according to the ground level of the receiver, and configured to control the voltage level of the second voltage signal.

The control unit may include a first switching unit adapted to selectively connect the first voltage signal to the first and second transmission lines, and a second switching unit adapted to selectively connect the second voltage signal to the first and second transmission lines. The first switching unit may include first and second switches, and wherein the second switching unit comprises third and fourth switches, the first through fourth switches including metal-oxide semiconductor (MOS) transistors.

The first and third transistors may be connected in series with each other, and the second and fourth transistors are connected in series with each other. The first and fourth switches may be simultaneously turned on or turned off, and wherein the second and third switches are simultaneously turned on or turned off complementarily with the first and fourth switches. The first and second voltage regulators may provide a common mode voltage corresponding to an average of the first and second output signals.

A resistance of each of the first and second resistors may be substantially half of a resistance of an external termination resistor that is connected between the first and second transmission lines.

The control unit may include a reference voltage generator configured to generate a reference voltage for the first and second voltage signals, a first voltage regulator configured to receive the reference voltage, configured to provide to the first transmission line a first output signal having a first voltage level according to a ground level of the receiver, and configured to control the voltage level of the first voltage signal such that the voltage level of the first voltage signal is higher than the ground level of the receiver, a second voltage regulator configured to receive the reference voltage, configured to provide to the second transmission line a second output signal having a second voltage level according to the ground level of the receiver, and configured to control the voltage level of the second voltage signal such that the voltage level of the second voltage signal is higher than the ground level of the receiver, and a switching circuit coupled to the first voltage regulator at a first node, and coupled to the second voltage regulator at a second node, the switching circuit being configured to selectively connect the first and second voltage signals to the first or second transmission lines, and configured to provide a source termination resistance matched with an external termination resistor that is connected between the first and second transmission lines, the source termination resistance at least partially based on the first and second resistors.

The switching circuit may include a first switch coupled to the first node, a second switch coupled to the first node in parallel with the first switch, a third resistor coupled in series to the first switch, the first resistor coupled in series to the second switch, a fourth resistor coupled in series to the third resistor at a third node, the second resistor coupled in series to the first resistor at a fourth node, a third switch coupled in series to the fourth resistor and coupled to the second node, and a fourth switch coupled in series to the second resistor and coupled to the second node, the third node being coupled to the second transmission line, the fourth node being coupled to the first transmission line.

The first and fourth switches may be simultaneously turned on or turned off, and wherein the second and third switches are simultaneously turned on or turned off complementarily with the first and fourth switches. A resistance of each of the first, second, third and fourth resistors may be substantially half of a resistance of the external termination resistor.

At least one of the above and other features and advantages of the invention may be separately realized by providing a low voltage data transmitting circuit (LVDTC) adapted to be connected to a first transmission line that transmits a first voltage signal to a receiver, a second transmission line that transmits a second voltage signal to the receiver, the LVDTC including a voltage regulator configured to receive a reference voltage for voltage signals that is used for data transmission to provide an output signal, and configured to control a voltage level of the output signal such that the voltage level of the output signal is higher than voltage levels of the first and second voltage signals, and an interface unit coupled between the voltage regulator and a ground voltage, the interface unit being configured to switch the output signal to provide the first and second voltage signals, and configured to provide a source termination resistance that is substantially the same as a characteristic impedance of the first and second transmission lines, wherein the first and second voltage signals constitute a differential pair.

The interface unit may include a switching unit coupled to the voltage regulator at a first node, and coupled to the ground voltage at a second node, and a source termination resistor unit coupled to the switching unit, the first and the second transmission lines. The switching unit may include a first switch coupled to the first node, a second switch coupled to the first node, a third switch coupled in series to the first switch at a third node, and coupled to the ground voltage at the second node, and a fourth switch coupled in series to the second switch at a fourth node, and coupled to the ground voltage at the second node.

The source termination resistor unit may include first, second and third resistors in a T-shaped configuration and coupled between the fourth node and the first transmission line, and fourth, fifth and sixth resistors in a T-shaped configuration and coupled between the third node and the second transmission line.

The first and second resistors may be coupled at a fifth node between the fourth node and the first transmission line, the third resistor may be coupled to the first and second resistors at the fifth node, the fourth and fifth resistors may be coupled at a sixth node between the third node and the second transmission line, the sixth resistor may be coupled to the fourth and fifth resistors at the sixth node, and the third and sixth resistors may be coupled at a seventh node.

Each of a first equivalent impedance of the first transmission line with respect to the interface unit and a second equivalent impedance of the first transmission line with respect to the receiver may be substantially the same as the characteristic impedance of the first transmission line, and wherein each of a third equivalent impedance of the second transmission line with respect to the interface unit and a fourth equivalent impedance of the second transmission line with respect to the receiver may be substantially the same as the characteristic impedance of the second transmission line.

The switching unit may include a first switch coupled to the first node, a second switch coupled to the first node, a first resistor coupled in series to the first switch, a second resistor coupled in series to the second switch, a third resistor coupled in series to the first resistor at a third node, a fourth resistor coupled in series to the second resistor at a fourth node, a third switch coupled in series to the third resistor and coupled to the second node, a fourth switch coupled in series to the fourth resistor and coupled to the second node.

The source termination resistor unit may include a fifth resistor coupled between a fifth node coupled to the fourth node and the first transmission line, a sixth resistor coupled in parallel to the fifth resistor at the fifth node, a seventh resistor coupled between a sixth node coupled to the third node and the second transmission line, and an eighth resistor coupled in parallel to the seventh resistor at the sixth node, and coupled to the sixth resistor at the seventh resistor.

At least one of the above and other features and advantages of the invention may be separately realized by providing a method of low voltage data transmission (LVDT), including transmitting a first voltage signal to a receiver through a first transmission, transmitting a second voltage signal to the receiver through a second transmission line, the first voltage signal and the second voltage signal constituting a differential pair, and controlling voltage levels of the first and second voltage signals such that the voltage levels of the first and second voltage signals are higher than a ground voltage level of the receiver.

Controlling voltage levels may include generating a reference voltage for the first and second voltage signal, outputting a first output signal for controlling the voltage level of the first voltage signal based on the reference voltage and the ground voltage of the receiver, outputting a second output signal for controlling the voltage level of the second voltage signal based on the reference voltage and the ground voltage of the receiver, and selectively connecting the first output signal and the second output signal to one of the first and second transmission lines.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a circuit diagram of a low voltage data transmitting circuit (LVDTC) according to an exemplary embodiment of the invention;

FIG. 2 illustrates a circuit diagram of the control unit employable by the LVDTC of FIG. 1;

FIGS. 3A and 3B illustrate circuit diagrams of exemplary embodiments of the first, second, third and fourth switches employable by the control circuit of FIG. 2;

FIG. 4 illustrates an operating state and signal paths when a first control signal of a high level and a second control signal of a low level are supplied to the switches of FIG. 3A;

FIG. 5 illustrates a circuit diagram of a receiver employable with the LVDTC of FIG. 1 according to an exemplary embodiment of the invention;

FIG. 6 illustrates a flow chart of an exemplary method for low voltage data transmission (LVDT) according to an exemplary embodiment of the invention;

FIG. 7 illustrates a flow chart of an exemplary method for executing step S330 of FIG. 6;

FIG. 8 illustrates a circuit diagram of an LVDTC according to another exemplary embodiment of the invention;

FIG. 9 illustrates a circuit diagram of an LVDTC according to another exemplary embodiment of the invention;

FIG. 10 illustrates a circuit diagram of an interface unit employable with the LVDTC of FIG. 9 according to another exemplary embodiment of the invention; and

FIG. 11 illustrates a circuit diagram setting forth an exemplary scenario in which impedance matching is accomplished in the exemplary embodiment of FIG. 10.

### DETAILED DESCRIPTION OF THE INVENTION

Korean Patent Application Nos. 2007-0022716, filed on Mar. 8, 2007, and 2007-0115186, filed on Nov. 13, 2007, in the Korean Intellectual Property Office, and entitled: “Low Voltage Data Transmitting Circuit,” are incorporated by reference herein in their entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

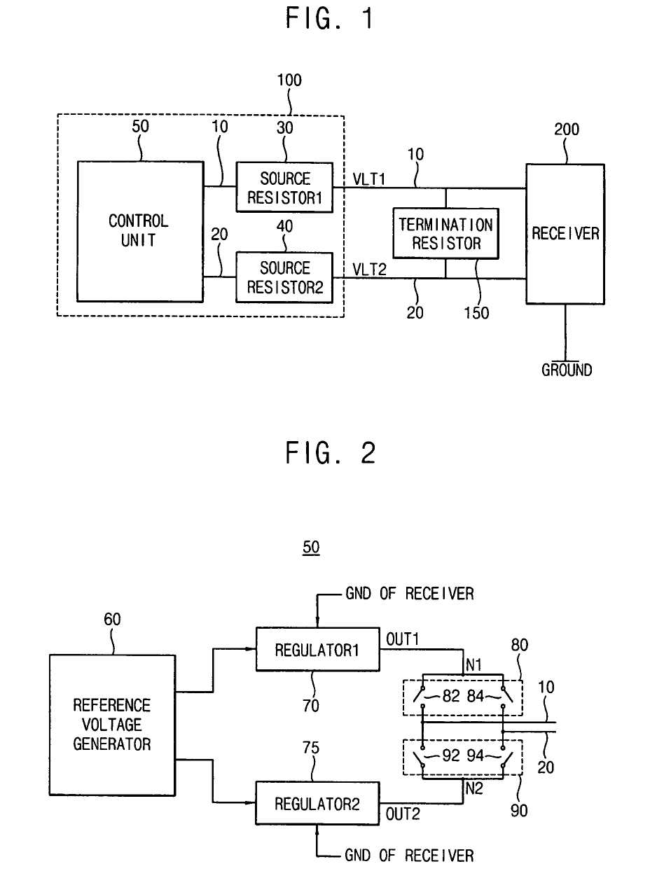

FIG. 1 illustrates a circuit diagram of a low voltage data transmitting circuit (LVDTC) 100 according to an exemplary embodiment of the invention. More particularly, FIG. 1 illustrates a circuit diagram of the LVDTC 100 coupled to a termination resistor 150 and a receiver 200.

Referring to FIG. 1, the LVDTC 100 may be connected a first transmission line 10 and a second transmission line 20, and may include a first source resistor 30, a second source resistor 40, and a control unit 50.

The LVDTC 100 may transmit a first voltage signal VLT1 to the receiver 200 through the first transmission line 10. The LVDTC 100 may transmit a second voltage signal VLT2 to the receiver 200 through the second transmission line 20. The first voltage signal VLT1 and the second voltage signal VLT2 may constitute a differential pair.

The first source resistor 30 may be coupled to the first transmission line 10 between the control unit 50 and the receiver 200. The second source resistor 40 may be coupled to the second transmission line 20 between the control unit 50 and the receiver 200. Resistance of the first source resistor 30 may be substantially the same as a resistance of the second source resistor 40. A resistance of the first source resistor 30 and a resistance of the second source resistor 40 may be substantially a half of a resistance of the termination resistor 150. The termination resistor 150 may be coupled between the first and second transmission lines 10 and 20. When a resistance of the first source resistor 30 and a second source resistor 40 are each substantially half of a resistance of a termination resistor 150, reflection of transmitted signals may be reduced. For example, if a resistance of the termination resistor 150 is about 100[Ω], a resistance of the first source resistor 30 and the second source resistor 40 may each be about 50[Ω]. The termination resistor 150 may be connected between the first transmission line 10 and the second transmission line 20.

The control unit 50 may be coupled to the first source resistor 30 through the first transmission line 10. The control unit 50 may be coupled to the second source resistor 40 through the second transmission line 20. The control unit 50 may control voltage levels of the first and second voltage signals VLT1 and VLT2 such that the voltage levels are sufficiently higher than a ground voltage level of the receiver 200 so that the receiver 200 may recognize the first and second voltage signals VLT1 and VLT2 correctly without error.

FIG. 2 illustrates a circuit diagram of the control unit 50 employable by the LVDTC 100 of FIG. 1.

Referring to FIG. 2, the control unit 50 may include a reference voltage generator 60, a first voltage regulator 70, a second voltage regulator 75, a first switching unit 80, and a second switching unit 90.

The reference voltage generator 60 may generate a reference voltage for voltage signal(s) used for data transmission, and may provide the reference voltage to the first and second voltage regulators 70 and 75.

The first voltage regulator 70 may receive the reference voltage from the reference voltage regulator 60 and a ground voltage level of the receiver 200, and may provide a first output signal OUT1 to a first node N1. The first voltage regulator 70 may control a voltage level of the first voltage signal VLT1 according to the ground voltage level of the receiver 200 such that the voltage level of the first voltage signal VLT1 is sufficiently higher than the ground voltage level of the receiver 200. The second voltage regulator 75 may receive the reference voltage from the reference voltage regulator 60 and the ground voltage level of the receiver 200, and may provide a second output signal OUT2 to a second node N2. The second voltage regulator 75 may control a voltage level of the second voltage signal VLT2 according to the ground voltage level of the receiver 200 such that the voltage level of the second voltage signal VLT2 is sufficiently higher than the ground voltage level of the receiver 200. When the voltage level of the second voltage signal VLT2 received by the receiver 200 is not sufficiently higher than the ground voltage level of the receiver 200, the receiver 200 may misinterpret the first and second voltage signals VLT1 and VLT2 or the receiver 200 may not recognize the first and second voltage signals VLT1 and VLT2 at all. As a result, an interface error may occur.

The first output signal OUT1 at the first node N1 may be selectively connected to the first and second transmission line 10 and 20 by first and second switches 82 and 84, which may be included in the first switching unit 80. The second output signal OUT2 at the second node N2 may be selectively connected to the first and second transmission line 10 and 20 by third and fourth switches 92 and 94, which may be included in the second switching unit 90. The first and fourth switches 82 and 94 may be simultaneously turned on or turned off. The second and third switches 84 and 92 may be simultaneously turned on or turned off. The second and third switches 84 and 92 may be complementary to the first and fourth switches 82 and 94 such that, e.g., when the second and third switches 84 and 92 are turned on, the first and fourth switches 82 and 94 may be turned off. The first and third switches 82 and 92 may be connected in series with each other, and the second and fourth switches 84 and 94 may be connected in series with each other. The first, second, third and fourth switches 82, 84, 92, and 94 may be implemented in various configurations.

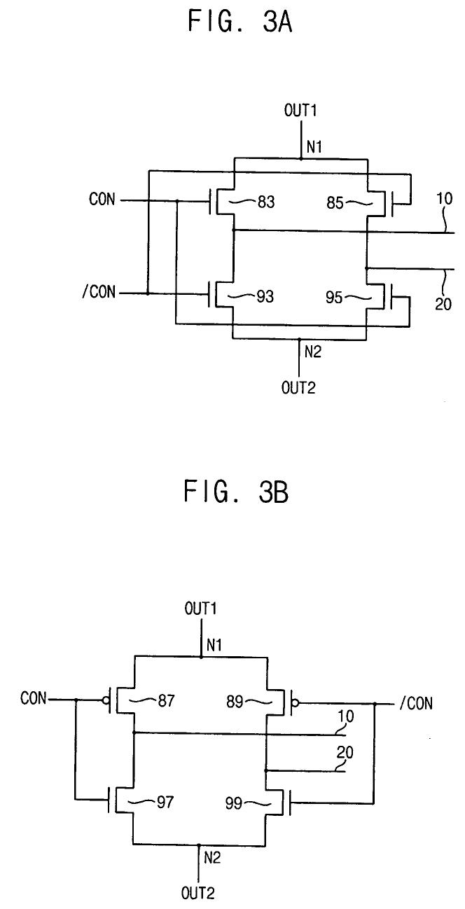

FIGS. 3A and 3B illustrate circuit diagrams of exemplary embodiments of the first, second, third and fourth switches 82, 84, 92 and 94 of the control circuit of FIG. 2.

In the exemplary embodiment illustrated in FIGS. 3A and 3B, the first, second, third and fourth switches 82, 84, 92, and 94 are implemented with metal-oxide semiconductor (MOS) transistors 83, 85, 93 and 95. However, embodiments are not limited thereto. That is, the first, second, third and fourth switches 82, 84, 92, and 84 may be implemented with another type of switch other than MOS transistors.

More particularly, in the exemplary embodiment illustrated in FIG. 3A, the first, second, third and fourth switches 82, 84, 92, and 94 are implemented with n-type MOS (NMOS) transistors 83, 85, 93 and 95. A first control signal CON may be applied to gates of the NMOS transistors 83 and 95. A second control signal/CON may be applied to gates of the NMOS transistors 85 and 93. The second control signal/CON may be inverse in phase with respect to the first control signal CON.

Although the exemplary embodiment illustrated in FIG. 3A is illustrated with all NMOS transistors, embodiments of the invention are not limited thereto. For example, in some embodiments, all of the first, second, third and fourth switches 82, 84, 92, and 94 may be implemented with PMOS transistors.

Referring to FIG. 3B, in the exemplary embodiment illustrated therein, the first, second, third and fourth switches 82, 84, 92, and 94 are implemented with p-type MOS (PMOS) transistors 87 and 89 and NMOS transistors 97 and 99. A first control signal CON may be applied to gates of the PMOS transistor 87 and the NMOS transistor 97. A second control signal/CON may be applied to gates of the PMOS transistor 89 and the NMOS transistor 99.

The first and second control signals CON and/CON may be simultaneously applied to the first and second switching units 80, 90. That is, e.g., the first control signal CON may be applied to first and fourth transistors 83 and 95 or 87 and 99 while the second control signal/CON is applied to the second and third transistors 85 and 93, 89 and 97 such that the first and fourth transistors 83 and 95 or 87 and 99 may act in a manner complementary to the second and third transistors 85 and 93, and 89 and 97.

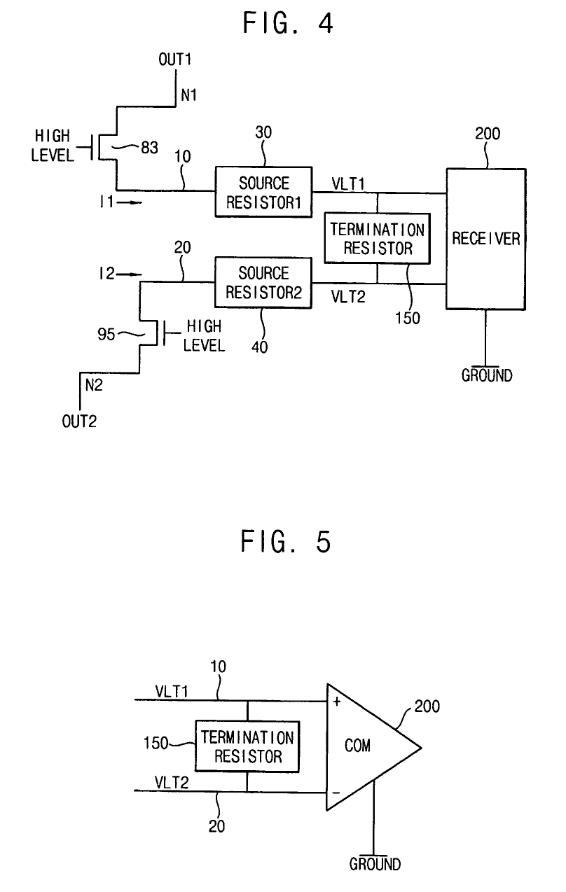

FIG. 4 illustrates an operating state and signal paths when the first control signal CON of a high level and the second control signal/CON of a low level are supplied to the switches of FIG. 3A.

Referring to FIG. 3A, when the first control signal CON is at a high level and the second control signal/CON is at a low level, the first and fourth transistors 83 and 95 are turned on, and the second and third transistors 85 and 93 are turned off. Thus, as illustrated in FIG. 4, current may flow through the first and fourth transistors 83, 95.

More particularly, when the first transistor 83 is turned on and current I1 corresponding to the first output signal OUT1 passes through the first source resistor 30, a voltage drop corresponding to I1*R_{SR1} may occur, where R_{SR1} is a resistance of the first source resistor 30, and the first output signal OUT1 may appear as a first voltage signal VLT1. When the fourth transistor 95 is turned on and current I2 corresponding to the second output signal OUT2 passes through the second source resistor 40, a voltage drop corresponding to I2*R_{SR2} may occur, where R_{SR2} is a resistance of the second source resistor 40, and the second output signal OUT2 may appear as a second voltage signal VLT2.

In some embodiments, by controlling voltage levels of the first and second output signals OUT1 and OUT2 with the first and second voltage regulators 70 and 75, magnitudes of the currents I1 and I2 may be controlled. Accordingly, voltage levels of the first and second voltage signals VLT1 and VLT2 supplied to the receiver 200 may be controlled such that the voltage levels of the first and second voltage signals VLT1 and VLT2 are sufficiently higher than the ground voltage level of the receiver 200.

The ground voltage level of the receiver 200 may be higher than a ground voltage level of the control unit 50. For example, in some embodiments, the receiver 200 may normally recognize a signal that has a swing margin of 200 mV and has a voltage level 400 mV higher than the ground voltage level of the receiver 200. In such cases, e.g., the receiver 200 may operate correctly, i.e., with no interface error, when the control unit 50 controls the first and second output signals OUT1 and OUT2 such that the first voltage signal VLT1 has a voltage level of 0.4[V] and the second voltage signal VLT2 has a voltage level of 0.6[V]. As such, the voltage level of the first voltage signal VLT1 may be controlled according to the ground voltage level of the receiver 200. In addition, a common mode voltage provided by the first and second voltage regulators 70 and 75 may correspond to an average of the first and second output signals OUT1 and OUT2, and thus, the common mode voltage may be easily controlled by the first and second output signals OUT1 and OUT2.

Hereinafter, a low voltage data transmitting system (LVDTS) according to an exemplary embodiment of the invention will be described with reference to FIGS. 1, 2, and 5.

FIG. 5 illustrates a circuit diagram of a receiver employable with the LVDTC of FIG. 1 according to an exemplary embodiment of the invention.

In the exemplary embodiment illustrated FIG. 5, the receiver 200 is implemented as a comparator. Referring to FIG. 5, the receiver 200 may include a non-inverting terminal (e.g., a positive (+) terminal) and an inverting terminal (e.g., a negative (−) terminal). The non-inverting terminal may receive the first voltage signal VLT1 through the first transmission line 10. The inverting terminal may receive the second voltage signal VLT2 through the second transmission line 20. The first voltage signal VLT1 and the second voltage signal VLT2 may constitute a differential pair. The receiver 200 may operate correctly when the first and second voltage signals VLT1 and VLT2 have sufficient swing margins and voltage levels are sufficiently higher than the ground voltage level.

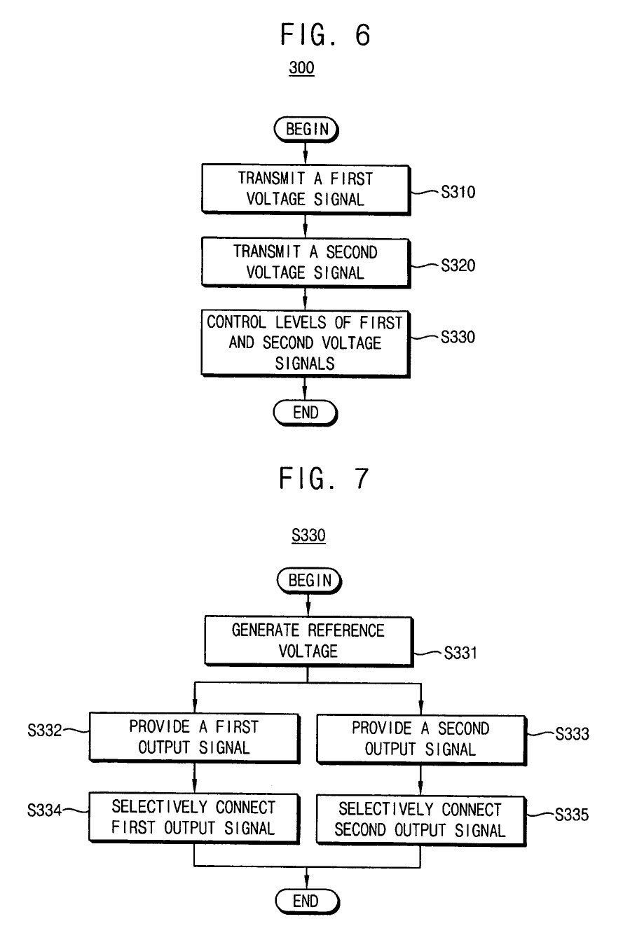

FIG. 6 illustrates a flow chart of an exemplary method for low voltage data transmission (LVDT) 300 according to an exemplary embodiment of the invention.

Referring to FIGS. 1 and 6, in the method of LVDT 300, a first voltage signal VLT1 may be transmitted to the receiver 200 through the first transmission line 10 (step S310). A second voltage signal VLT2 may be transmitted to the receiver 200 through the second transmission line 20 (step S320). The first voltage signal VLT1 and the second voltage signal VLT2 may constitute a differential pair. Voltage levels of the first and second voltage signals VLT1 and VLT2 may be controlled such that the voltage levels are sufficiently higher than a ground voltage level of the receiver 200 so that the receiver 200 may recognize the first and second voltage signals VLT1 and VLT2.

FIG. 7 illustrates a flow chart of an exemplary method for executing step S330 of FIG. 6.

Referring to FIGS. 2 and 7, in the step S330, a reference voltage for voltage signal(s) used for data transmission may be generated (step S331). The reference voltage may be received and a first output signal OUT1 may be provided to control the voltage level of the first voltage signal VLT1 according to the ground voltage level of the receiver 200 (step S332). The reference voltage may be received and a second output signal OUT2 may be provided to control the voltage level of the second voltage signal VLT2 according to the ground voltage level of the receiver 200 (step S333). The first output signal OUT1 may be selectively connected to the first and second transmission lines 10 and 20 (step S334). The second output signal OUT2 may be selectively connected to the first and second transmission lines 10 and 20 (step S335). Detailed description of the method of LVDT 300 is substantially the same as the operation of the LVDTS in FIGS. 1 and 2, and will not be repeated.

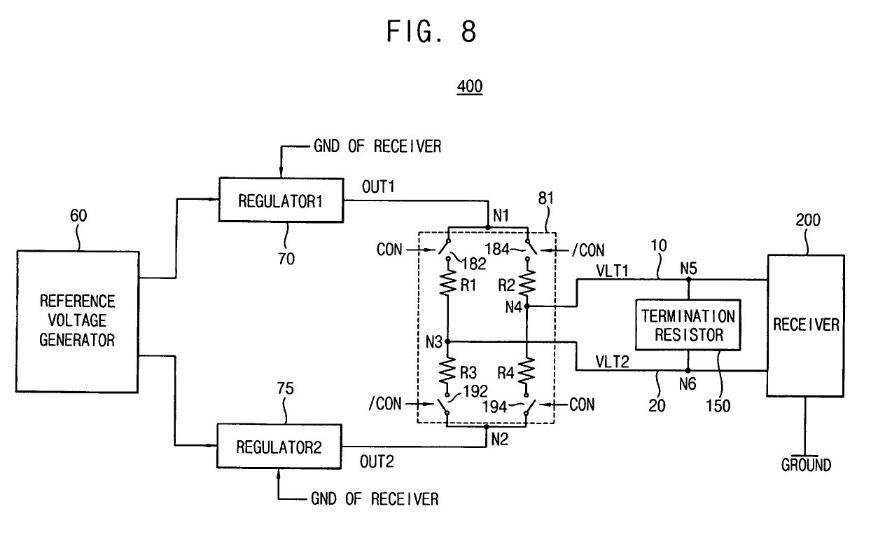

FIG. 8 illustrates a circuit diagram of an LVDTC 400 according to another exemplary embodiment of the invention. In general, only differences between the LVDTC 400 of FIG. 8 and the LVDTC 100 of FIG. 1 will be described.

The LVDTC 400 of FIG. 8 may have a circuit architecture such that resistors R1, R2, R3 and R4 are included in a switching circuit 81 of the LVDTC 400. The resistors R1, R2, R3 and R4 may be in lieu of the source resistors 30 and 40 of the exemplary embodiment shown in FIG. 4.

Referring to FIG. 8, the LVDTC 400 may be coupled to the first transmission line 10 and the second transmission line 20, and may include the reference voltage generator 60, the first voltage regulator 70, the second voltage regulator 75, and the switching circuit 81. Operations of the first transmission line 10, the second transmission line 20, the reference voltage generator 60, the first voltage regulator 70, and the second voltage regulator 75 are substantially the same as the operations of the corresponding elements in the LVDTC 100, as described above with regard to FIGS. 1 through 4, and thus, will not be repeated.

The switching circuit 81 may be coupled to the first voltage regulator 70 at a first node N1, and coupled to the second voltage regulator 75 at a second node N2. The switching circuit 81 may selectively connect the first and second output signals OUT1 and OUT2 to the first and second transmission lines 10 and 20. In addition, the switching circuit 81 may provide a source termination resistance matched with the external termination resistor 150, which may be connected between the first and second transmission lines 10 and 20.

The switching circuit 81 may include a plurality of switches, e.g., first, second, third and fourth switches 182, 184, 192, and 194, and a plurality of resistors, e.g., first, second, third and fourth resistors R1, R2, R3 and R4. The first switch 182 may be selectively coupled to the first node N1 and the first resistor R1. The second switch 184 may be coupled to the first node N1 and the second resistor R2. The third switch 192 may be coupled to the second node N2 and the third resistor R3. The fourth switch 194 may be coupled to the second node N2 and the fourth resistor R4. The first and third resistors R1 and R3 may be coupled at a third node N3. The second and fourth resistors R2 and R4 may be coupled at a fourth node N4. The third node N3 may be coupled to the first transmission line 10. The fourth node N4 may be coupled to the second transmission line 20.

A first control signal CON may be applied to the first and fourth switches 182 and 194. A second control signal/CON may be applied to the second and third switches 184 and 192. The first control signal CON may be complementary with the second control signal/CON. When a resistance of each of the resistors R1, R2, R3 and R4 is substantially half of a resistance of the external termination resistor 150, impedances are matched and signal reflection, which may occur on the transmission lines 10 and 20, may be reduced. For example, when a characteristic impedance of each of the first and second transmission lines 10 and 20 is about 65[Ω], impedance matching may be accomplished by setting a resistance of the external termination resistor 150 to about 130[Ω], and a resistance of each of the resistors R1, R2, R3 and R4 to about 65[Ω].

More particularly, in some embodiments, e.g., when a voltage level of the first output signal OUT1 is about 0.7[V], a voltage level of the second output signal OUT2 is about 0.3[V], a characteristic impedance of each of the first and second transmission lines 10 and 20 is about 65[Ω], a resistance of the external termination resistor 150 is about 130[Ω], and a resistance of each of the resistors R1, R2, R3 and R4 is about 65[Ω], a voltage level of the first voltage signal VLT1 at a fifth node N5 may swing between about 0.6[V] to about 0.4[V], and a voltage level of the second voltage signal VLT2 at a sixth node N6 may swing about 0.4[V] to about 0.6[V] in common mode. Accordingly, voltage induced at the external termination resistor 150 may swing between about 0.5[V] to about 0.1666[V], and thus an output may be stabilized.

In some embodiments, e.g., the exemplary circuit of FIG. 8, when impedance matching is accomplished, short-circuit current may be reduced and/or eliminated. Short-circuit current may exist when, e.g., the first and third switches 182 and 192 are turned on, or when the second and fourth switches 184 and 194 are turned on. In some embodiments, even if short-circuit current does exist, an amount of the short-circuit current may be reduced because voltage drops when the short-circuit current passes through the first and third resistors R1 and R3 or the second and fourth resistors R2 and R4.

In some embodiments, the switches 182, 184, 192, 194 of FIG. 8 may be implemented with, e.g., NMOS transistors and/or PMOS transistors as illustrated in FIGS. 3A and 3B. However, embodiments are not limited thereto.

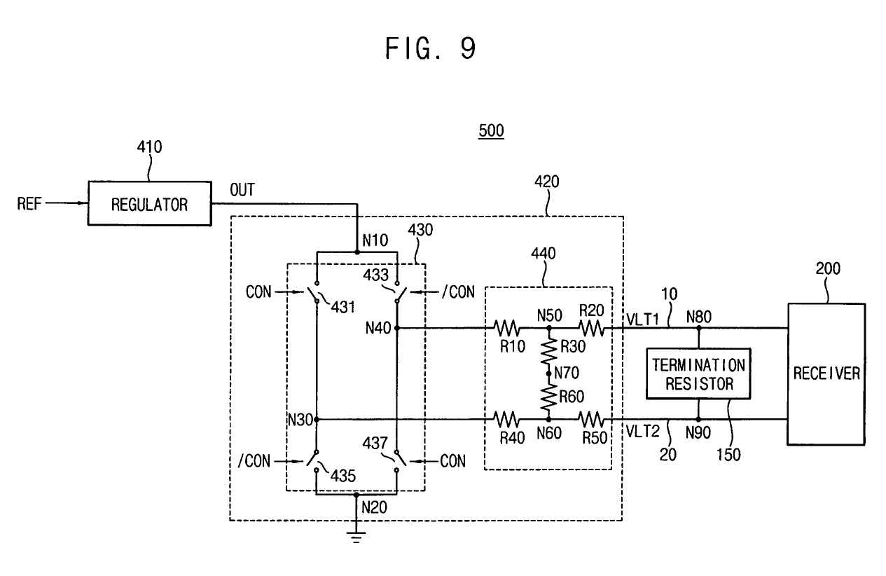

FIG. 9 illustrates a circuit diagram of an LVDTC 500 according to another exemplary embodiment of the invention. In general, only differences between the LVDTC 500 of FIG. 9, the LVDTC 400 of FIG. 8, and the LVDTC 100 of FIG. 1 will be described.

Referring to FIG. 9 the LVDTC 500 may be coupled to the first transmission line 10 and the second transmission line 20, and may include a voltage regulator 410 and an interface unit 420.

The first transmission line 10 may transmit a first voltage signal VLT1 to the receiver 200. The second transmission line 20 may transmit a second voltage signal VLT2 to the receiver 200. The first voltage signal VLT1 and the second voltage signal VLT2 may constitute a differential pair.

The voltage regulator 410 may receive a reference voltage REF for voltage signals that are used during data transmission to provide an output signal OUT. The voltage regulator 410 may control a voltage level of the output signal OUT such that the voltage level of the output signal OUT is higher than voltage levels of the first and second voltage signals VLT1 and VLT2.

The interface unit 420 may include a switching unit 430 and a source termination resistor unit 440. The switching unit 430 may be coupled to the voltage regulator 410 at a node N10, and may be coupled to a ground voltage at a second node N20. The switching unit 430 may include switches, e.g., first, second, third and fourth switches 431, 433, 435, 437. The first switch 431 may be coupled to the first node N10, and may be coupled to a third node N30. The second switch 433 may be coupled to the first switch 431 at the first node N10, and may also be coupled to a fourth node N40. The third switch 435 may be coupled to the first switch 431 at the third node N30, and may also be coupled to the second node N20. The fourth switch 437 may be coupled to the second switch 433 at the fourth node N40, and may also be coupled to the second node N20. A first control signal CON may be applied to the first and fourth switches 431 and 437, and a second control signal/CON may be applied to the second and third switches 433 and 435. The first control signal CON may be complementary with the second control signal/CON. More particularly, in some embodiments, e.g., in an embodiment where the first, second, third and fourth switches 431, 433, 435 and 437 are all NMOS transistors, the first and fourth switches 431 and 437 may be simultaneously turned on or turned off, and the second and third switches 433 and 435 may be simultaneously turned on or turned off in complement with the first and fourth switches 431 and 437.

The source termination resistor unit 440 may be coupled to the first and second transmission lines 10 and 20. The source termination resistor unit 440 may include resistors, e.g., first, second, third, fourth, fifth and sixth resistors R10, R20, R30, R40, R50, and R60. The first, second and third resistors R10, R20, and R30 may form a T configuration. The fourth, fifth and sixth resistors R40, R50, and R60 may form another T configuration symmetrically with the first, second and third resistors R10, R20, and R30. The first resistor R10 may be coupled to the fourth node N40, the second resistor R20 may be coupled to the first transmission line 10. The first and second resistors R10 and R20 may be coupled to each other at a fifth node N50. The third resistor R30 may be coupled to the node N50. The fourth resistor R40 may be coupled to the third node N30, and the fifth resistor R50 may be coupled to the second transmission line 20. The fourth resistor R40 and the fifth resistor R50 may also be coupled to a sixth node N60. The sixth resistor R60 may be coupled to the sixth node N60. The third and sixth resistors R30 and R60 may be coupled to each other at a node N7.

When a first equivalent impedance of the first transmission line 10 with respect to the interface unit 420 and a second equivalent impedance of the first transmission line 10 with respect to the receiver 200 are each substantially the same as the characteristic impedance of the first transmission line 10, impedance matching may be accomplished. In addition, when a third equivalent impedance of the second transmission line 20 with respect to the interface unit 420 and a fourth equivalent impedance of the second transmission line 20 with respect to the receiver 200 are each substantially the same as the characteristic impedance of the second transmission line 20, impedance matching may be accomplished. When impedance matching is accomplished, signal reflection, which may occur on the first and second transmission lines 10 and 20, may be reduced and/or eliminated.

For example, when a characteristic impedance of each of the first and second transmission lines 10 and 20 is about 65[Ω], impedance matching may be accomplished by setting a resistance of the external termination resistor 150 to about 130[Ω], setting a resistance of each of the first, second and third resistors R10, R20, and R30 to about 81.25[Ω], about 16.25[Ω] and about 121.875[Ω], respectively, and setting a resistance of each of the fourth, fifth and sixth resistors R40, R50, and R60 to about 81.25[Ω], about 16.25[Ω] and about 121.875[Ω], respectively. In such an exemplary embodiment, an equivalent impedance of the first transmission line 10 with respect to the external termination resistor 150 may be substantially half of a resistance of the external termination resistor 150, i.e. about 65[Ω], and a first equivalent impedance of the first transmission line 10 with respect to the interface unit 420 may correspond to 16.25[Ω]+(81.25[Ω]//121.875[Ω]), i.e. 16.25[Ω]+((81.25[Ω]*121.875[Ω])/(81.25[Ω]+121.875[Ω]))=about 65[Ω]. The same is applicable to the fourth, fifth and sixth resistors R40, R50, and R60.

When a voltage level of the output signal OUT at the first node N10 is about 1.0[V], a characteristic impedance of each of the first and second transmission lines 10 and 20 is about 65[Ω], a resistance of the external termination resistor 150 is about 130[Ω], a resistance of each of the first, second and third resistors R10, R20 and R30 is about 81.25[Ω], about 16.25[Ω] and about 121.875[Ω], respectively, and a resistance of each of the fourth, fifth and sixth resistors R4, R5 and R6 is about 81.25[Ω], about 16.25[Ω] and about 121.875[Ω], respectively, a voltage level of the first voltage signal VLT1 at an eighth node N80 may swing between about 0.67[V] to about 0.33[V], and a voltage level of the second voltage signal VLT2 at a ninth node N90 may swing between about 0.33[V] to about 0.67[V] in common mode. Accordingly, in such an exemplary embodiment, a voltage induced at the external source resistor 150 may swing between about 0.5[V] to about 0.1666[V], and thus the output can be stabilized. It is understood that the values provided above are merely exemplary, and embodiments of the invention are not limited to thereto.

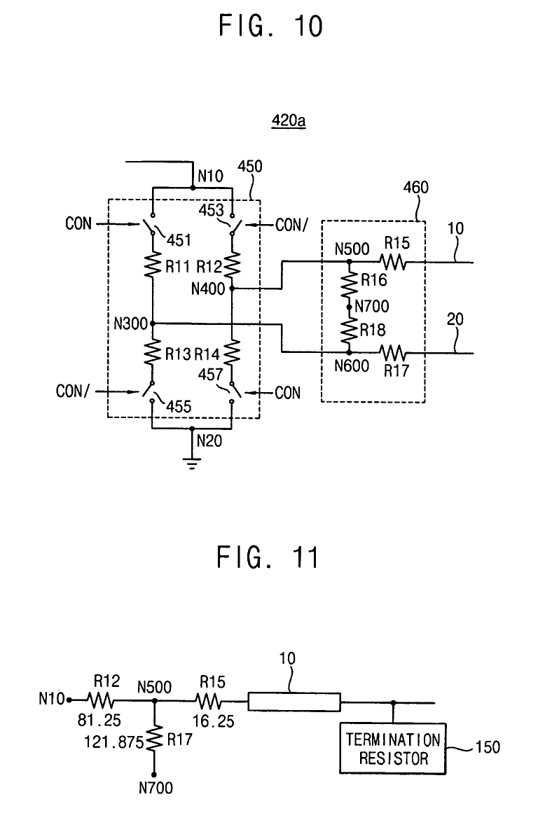

FIG. 10 illustrates a circuit diagram of an interface unit 420a employable with the LVDTC of FIG. 9 according to another exemplary embodiment of the invention.

In general, only differences between the interface unit 420 of FIG. 9 and the interface unit 420a of FIG. 10 will be described. Referring to FIG. 10, the interface unit 420a may include a switching unit 450 and a source termination resistor unit 460.

The switching unit 450 may be coupled to the voltage regulator 410 at the first node N10 and may be coupled to the ground voltage at the second node N20. The switching unit 450 may include switches, e.g., first, second, third and fourth switches 451, 453, 455, and 457, and resistors, e.g., first, second, third, and fourth resistors R11, R12, R13 and R14. The first switch 451 may be coupled to the first node N10 and the first resistor R11. The second switch 453 may be coupled to the first node N10 and the second resistor R12. The third switch 455 may be coupled to the second node N20 and the third resistor R13. The fourth switch 457 may be coupled to the second node N20 and the fourth resistor R14. The first and third resistors R11 and R13 may be coupled to each other at a third node N300. The second and fourth resistors R12 and R14 may be coupled to each other at a fourth node N400. The third node N300 may be coupled to the first transmission line 10, and the fourth node N400 may be coupled to the second transmission line 20.

A first control signal CON may be applied to the first and fourth switches 451 and 457, and a second control signal/CON may be applied to the second and third switches 453 and 455. The first control signal CON may be complementary with the second control signal/CON. More particularly, in some embodiments, e.g., in an embodiment where the first, second, third and fourth switches 431, 433, 435 and 437 are all NMOS transistors, the first and fourth switches 451 and 457 may be simultaneously turned on or turned off, and the second and third switches 453 and 455 may be simultaneously turned on or turned off complementarily with the first and fourth switches 451 and 457. The first, second, third and fourth switches 451, 453, 455, and 457 may be implemented with NMOS transistors and/or PMOS transistors.

The source termination resistor unit 460 may be coupled to the first and second transmission lines 10 and 20. The source termination resistor unit 460 may include first, second, third and fourth resistors R15, R16, R17 and R18. The first resistor R15 may be coupled between a fifth node N500, which may be coupled to the fourth node N400 and the first transmission line 10. The second resistor R16 may be coupled to the first resistor R15 at the fifth node N500. The third resistor R17 may be coupled between a sixth node N600, which may be coupled to the third node N300 and the second transmission line 20. The fourth resistor R18 may be coupled to the third resistor R17 at the sixth node N600. The second and fourth resistors R16 and R18 may be coupled to each other at a seventh node N700.

When a first equivalent impedance of the first transmission line 10 with respect to the interface unit 420a and a second equivalent impedance of the first transmission line 10 with respect to the receiver 200 are both substantially the same as a characteristic impedance of the first transmission line 10, impedance matching may be accomplished. In addition, when each of a third equivalent impedance of the second transmission line 20 with respect to the interface unit 420a and a fourth equivalent impedance of the second transmission line 20 with respect to the receiver 200 is substantially the same as the characteristic impedance of the second transmission line 20, impedance matching may be accomplished. When the impedance matching is accomplished, signal reflection, which may occur on the first and second transmission lines 10 and 20, may be reduced and/or eliminated.

For example, when the characteristic impedance of each of the first and second transmission lines 10 and 20 is about 65[Ω], impedance matching may be accomplished by setting a resistance of the external termination resistor 150 to about 130[Ω], setting a resistance of each of the resistors first, second, third and fourth R11, R12, R13 and R14 to about 81.25[Ω], respectively, and setting a resistance of each of the first, second, third and fourth resistors R15, R16, R17, and R18 to about 16.25[Ω], about 81.25[Ω], about 16.25[Ω] and about 81.25[Ω], respectively.

FIG. 11 illustrates a circuit diagram setting forth an exemplary scenario in which impedance matching is accomplished in the exemplary embodiment of FIG. 10. In FIG. 11, only the first transmission line 10 is illustrated, i.e., the second transmission line 20 is not illustrated.

More particularly, FIG. 11 illustrates that impedance matching may be accomplished in FIG. 10 when, e.g., the first and fourth switches 451 and 457 are turned on.

Referring to FIG. 11, equivalent impedance of the first transmission line 10 with respect to the external termination resistor 150 may be substantially half of a resistance of the external termination resistor 150, i.e. about 65[Ω], and a first equivalent impedance of the first transmission line 10 with respect to the interface unit 420a may correspond to 16.25[Ω]+(81.25[Ω]//121.875[Ω]), i.e. about 65[Ω], because the first and seventh nodes N10 and N700 are virtually grounded. Accordingly, impedance matching may be accomplished. The circuit architecture of interface unit 420a in FIG. 10 may be employed by the interface unit 420 of FIG. 9 to provide a stable output.

In some embodiments, an LVDTC, an LVDTS and/or a method of LVDT employing one or more aspects of the invention may transmit signals stably without interface errors by controlling voltage levels of voltage signals such that the voltage levels recognized by a receiver are sufficiently higher than a ground voltage level of the receiver. Some embodiments of the invention may employ first and second voltage regulators to control voltage levels of the voltage signals.

In some embodiments, an LVDTC employing one or more aspects of the invention may output a stable output waveform by reducing short-circuit current, which may occur during a switching operation.

In some embodiments, an LVDTC employing one or more aspects of the invention may reduce a circuit size and may provide a desired termination resistance.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A low voltage data transmitting circuit (LVDTC) adapted to be connected to a first transmission line that transmits a first voltage signal to a receiver and a second transmission line that transmits a second voltage signal to the receiver, the LVDTC comprising:
a first resistor coupled to the first transmission line;
a second resistor coupled to the second transmission line; and
a control unit coupled to the first transmission line and the second transmission line, the control unit being configured to control voltage levels of the first and second voltage signals such that the voltage levels of the first and second voltage signals are higher than a ground voltage level of the receiver,
wherein the first and second voltage signals constitute a differential pair.

2. The LVDTC as claimed in claim 1, wherein the control unit comprises:
a reference voltage generator configured to generate a reference voltage for the first and second voltage signals;
a first voltage regulator configured to receive the reference voltage, configured to provide a first output signal having a first voltage level according to the ground level of the receiver, and configured to control the voltage level of the first voltage signal; and
a second voltage regulator configured to receive the reference voltage, configured to provide a second output signal having a second voltage level according to the ground level of the receiver, and configured to control the voltage level of the second voltage signal.

3. The LVDTC as claimed in claim 2, wherein the control unit further comprises:
a first switching unit adapted to selectively connect the first voltage signal to the first and second transmission lines; and
a second switching unit adapted to selectively connect the second voltage signal to the first and second transmission lines.

4. The LVDTC as claimed in claim 3, wherein the first switching unit comprises first and second switches, and wherein the second switching unit comprises third and fourth switches, the first through fourth switches including metal-oxide semiconductor (MOS) transistors.

5. The LVDTC as claimed in claim 4, wherein the first and third transistors are connected in series with each other, and the second and fourth transistors are connected in series with each other.

6. The LVDTC as claimed in claim 5, wherein the first and fourth switches are simultaneously turned on or turned off, and wherein the second and third switches are simultaneously turned on or turned off complementarily with the first and fourth switches.

7. The LVDTC as claimed in claim 1, wherein the first and second voltage regulators provide a common mode voltage corresponding to an average of the first and second output signals.

8. The LVDTC as claimed in claim 1, wherein a resistance of each of the first and second resistors is substantially half of a resistance of an external termination resistor that is connected between the first and second transmission lines.

9. The LVDTC as claimed in claim 1, wherein the control unit comprises:
a reference voltage generator configured to generate a reference voltage for the first and second voltage signals;
a first voltage regulator configured to receive the reference voltage, configured to provide to the first transmission line a first output signal having a first voltage level according to a ground level of the receiver, and configured to control the voltage level of the first voltage signal such that the voltage level of the first voltage signal is higher than the ground level of the receiver;
a second voltage regulator configured to receive the reference voltage, configured to provide to the second transmission line a second output signal having a second voltage level according to the ground level of the receiver, and configured to control the voltage level of the second voltage signal such that the voltage level of the second voltage signal is higher than the ground level of the receiver; and
a switching circuit coupled to the first voltage regulator at a first node, and coupled to the second voltage regulator at a second node, the switching circuit being configured to selectively connect the first and second voltage signals to the first or second transmission lines, and configured to provide a source termination resistance matched with an external termination resistor that is connected between the first and second transmission lines, the source termination resistance at least partially based on the first and second resistors.

10. The LVDTC as claimed in claim 9, wherein the switching circuit comprises:
a first switch coupled to the first node;
a second switch coupled to the first node in parallel with the first switch;
a third resistor coupled in series to the first switch;
the first resistor coupled in series to the second switch;
a fourth resistor coupled in series to the third resistor at a third node;
the second resistor coupled in series to the first resistor at a fourth node;
a third switch coupled in series to the fourth resistor and coupled to the second node; and
a fourth switch coupled in series to the second resistor and coupled to the second node, the third node being coupled to the second transmission line, the fourth node being coupled to the first transmission line.

11. The LVDTC as claimed in claim 10, wherein the first and fourth switches are simultaneously turned on or turned off, and wherein the second and third switches are simultaneously turned on or turned off complementarily with the first and fourth switches.

12. The LVDTC as claimed in claim 10, wherein a resistance of each of the first, second, third and fourth resistors is substantially half of a resistance of the external termination resistor.

13. A low voltage data transmitting circuit (LVDTC) adapted to be connected to a first transmission line that transmits a first voltage signal to a receiver, a second transmission line that transmits a second voltage signal to the receiver, the LVDTC comprising:
a voltage regulator configured to receive a reference voltage for voltage signals that is used for data transmission to provide an output signal, and configured to control a voltage level of the output signal such that the voltage level of the output signal is higher than voltage levels of the first and second voltage signals; and
an interface unit coupled between the voltage regulator and a ground voltage, the interface unit being configured to switch the output signal to provide the first and second voltage signals, and configured to provide a source termination resistance that is substantially the same as a characteristic impedance of the first and second transmission lines, wherein the first and second voltage signals constitute a differential pair.

14. The LVDTC as claimed in claim 13, wherein the interface unit comprises:
a switching unit coupled to the voltage regulator at a first node, and coupled to the ground voltage at a second node; and
a source termination resistor unit coupled to the switching unit, the first and the second transmission lines.

15. The LVDTC as claimed in claim 14, wherein the switching unit comprises:
a first switch coupled to the first node;
a second switch coupled to the first node;
a third switch coupled in series to the first switch at a third node, and coupled to the ground voltage at the second node; and
a fourth switch coupled in series to the second switch at a fourth node, and coupled to the ground voltage at the second node.

16. The LVDTC as claimed in claim 15, wherein the source termination resistor unit includes first, second and third resistors in a T-shaped configuration and coupled between the fourth node and the first transmission line, and fourth, fifth and sixth resistors in a T-shaped configuration and coupled between the third node and the second transmission line.

17. The LVDTC as claimed in claim 16, wherein the first and second resistors are coupled at a fifth node between the fourth node and the first transmission line, the third resistor is coupled to the first and second resistors at the fifth node, the fourth and fifth resistors are coupled at a sixth node between the third node and the second transmission line, the sixth resistor is coupled to the fourth and fifth resistors at the sixth node, and the third and sixth resistors are coupled at a seventh node.

18. The LVDTC as claimed in claim 17, wherein each of a first equivalent impedance of the first transmission line with respect to the interface unit and a second equivalent impedance of the first transmission line with respect to the receiver is substantially the same as the characteristic impedance of the first transmission line, and wherein each of a third equivalent impedance of the second transmission line with respect to the interface unit and a fourth equivalent impedance of the second transmission line with respect to the receiver is substantially the same as the characteristic impedance of the second transmission line.

19. The LVDTC as claimed in claim 14, wherein the switching unit comprises:
a first switch coupled to the first node;
a second switch coupled to the first node;
a first resistor coupled in series to the first switch;
a second resistor coupled in series to the second switch;
a third resistor coupled in series to the first resistor at a third node;
a fourth resistor coupled in series to the second resistor at a fourth node;
a third switch coupled in series to the third resistor and coupled to the second node; and
a fourth switch coupled in series to the fourth resistor and coupled to the second node.

20. The LVDTC as claimed in claim 19, wherein the source termination resistor unit comprises:
a fifth resistor coupled between a fifth node coupled to the fourth node and the first transmission line;
a sixth resistor coupled in parallel to the fifth resistor at the fifth node;
a seventh resistor coupled between a sixth node coupled to the third node and the second transmission line; and
an eighth resistor coupled in parallel to the seventh resistor at the sixth node, and coupled to the sixth resistor at the seventh resistor.

21. The LVDTC as claimed in claim 20, wherein each of a first equivalent impedance of the first transmission line with respect to the interface unit and a second equivalent impedance of the first transmission line with respect to the receiver is substantially the same as the characteristic impedance of the first transmission line, and wherein each of a third equivalent impedance of the second transmission line with respect to the interface unit and a fourth equivalent impedance of the second transmission line with respect to the receiver is substantially the same as the characteristic impedance of the second transmission line.

22. A method of low voltage data transmission (LVDT), comprising:
transmitting a first voltage signal to a receiver through a first transmission line;
transmitting a second voltage signal to the receiver through a second transmission line, the first voltage signal and the second voltage signal constituting a differential pair; and
controlling voltage levels of the first and second voltage signals such that the voltage levels of the first and second voltage signals are higher than a ground voltage level of the receiver.

23. The method as claimed in claim 22, wherein controlling voltage levels comprises;
generating a reference voltage for the first and second voltage signal;
outputting a first output signal for controlling the voltage level of the first voltage signal based on the reference voltage and the ground voltage of the receiver;
outputting a second output signal for controlling the voltage level of the second voltage signal based on the reference voltage and the ground voltage of the receiver; and
selectively connecting the first output signal and the second output signal to one of the first and second transmission lines.
